(19) United States
(12) Patent Application Publication
(10) Pub. No.: US 2011/0059004 A1
(43) Pub. Date: Mar. 10, 2011

(54) System and Method for Controlling the System for the Production of Polycrystalline Silicon

(75) Inventor: Robert Stöcklinger, Feldkirchen-Westerham (DE)

(73) Assignee: G+R POLYSILICON GMBH, Regenstauf (DE)

(21) Appl. No.: 12/581,552

(22) Filed: Oct. 19, 2009

(30) Foreign Application Priority Data
Sep. 4, 2009 (DE) 10 2009 043 946.3

(51) Int. Cl. G05B 21/00; B01J 19/00

(52) U.S. Cl. 423/348; 422/119; 422/108; 422/111; 700/268

(57) ABSTRACT

A system and a method for the production of polycrystalline silicon according to the monosilane process are disclosed. At least one reactor (10), at least one converter (20), at least one injection tank (30) and at least one vaporizer (40) are provided. Each reactor (10) is provided with an inlet pipe (11a) for fresh mixtures of gases and an outlet pipe (11b) for partially used-up mixtures of gases. Likewise, each converter (20) comprises an outlet pipe (21) for a mixture of gases and each vaporizer (40) comprises an outlet pipe (41) for a mixture of gases. Several sampling elements (7) for specimens to be measured are provided in the inlet pipe (11a) and the outlet pipe (11b) of each reactor (10) as well as in the outlet pipe (21) of each converter (20) and the outlet pipe (41) of each vaporizer (40). The withdrawn specimens to be measured are fed by the sampling elements (7) via a pipe (8) to at least one gas-phase chromatograph (2).

### RELATED APPLICATIONS

This application claims priority to German Patent Application No. 10 2009 043 946.3, filed on Sep. 4, 2009, which is incorporated herein by reference in its entirety.

### FIELD OF THE INVENTION

The present invention relates to a system for the production of polycrystalline silicon.

Furthermore, the invention relates to a method for controlling the system for the production of polycrystalline silicon. Thereby, the system comprises at least one reactor.

### BACKGROUND OF THE INVENTION

The polycrystalline silicon can be produced according to the monosilane process or the Siemens process. Both methods substantially differ in the reaction partners, with which the polycrystalline silicon is produced.

In the Siemens process, trichlorosilane (SiHCl₃) is thermally decomposed in presence of hydrogen on heated high-purity silicon rods at 1000 to 2000° C. The pure silicon is thereby deposited onto the rods. The hydrogen chloride released in the process is fed back into the production. The process takes place at a pressure of approximately 6.5 bar.

In the monosilane process, monosilane (SiH₄) is thermally decomposed in presence of hydrogen on heated high-purity silicon rods at 850 to 900° C. The pure silicon is thereby deposited onto the rods. The monosilane process takes place at a pressure of approximately 2 to 2.5 bar.

A system for the production of polycrystalline silicon can thereby comprise a plurality of reactors, in which the silicon deposits onto the filament rods in the interior space of the reactors. Furthermore, further elements such as an injection tank, a vaporizer for reaction gas and several converters are provided in the system. As already mentioned, the system can have only one reactor in the basic embodiment. It is obvious for a person skilled in the art that the size of the system conforms to the demands of the customer with reference to the number and type of the individual elements.

The yield of deposition of polycrystalline silicon at the filament rods depends thereby very much on the process conditions. According to the monosilane process or the Siemens process the putting into operation and/or commissioning of a system for the production of polycrystalline silicon requires also a significant amount of time and manpower, in order to adjust the parameters, which are mutually dependant on each other, such as pressure, temperature, composition of the reaction gas, composition of the abstracted gas from the components of the system, composition and quantity of the mixture of gases, with which the different elements of the systems are fed etc. Thus, significant costs and time are required in order to put a system for the production of polycrystalline silicon into operation after said system has been assembled.

### SUMMARY OF THE INVENTION

The object of the invention is to create a system for the production of polycrystalline silicon, which is as automatically put into operation as possible and wherein an efficient operation of the system is possible, which results in high product quality and an increased operating safety.

The object is achieved with a system for the production of polycrystalline silicon comprising:
at least one reactor;
in each case a sampling element for specimens to be measured is provided in an inlet pipe and an outlet pipe of the at least one reactor;
at least one gas-phase chromatograph for analyzing the withdrawn specimens; and
a pipe connects each sampling element and the gas-phase chromatograph.

A further object of the invention is to create a method with which the system for the production of polycrystalline silicon can be operated in a cost-saving way and wherein an efficient operation of the system is possible, which results in high product quality and an increased operating safety.

This object is achieved with a method for controlling a system for the production of polycrystalline silicon, wherein the system has at least one reactor with at least one inlet pipe and an outlet pipe for a mixture of gases, comprising the following steps:
withdrawing specimens to be measured from the inlet pipe and the outlet pipe of each reactor;
feeding the withdrawn specimens to be measured to at least one gas-phase chromatograph via a pipe;
obtaining controlling signals on the basis of the measurements with respect to the composition of the fed specimens to be measured obtained by the gas-phase chromatograph; and
adjusting a plurality of parameters of the at least one reactor on the basis of the obtained controlling signals by means of a control unit via actuators n such a way that the efficiency of the system automatically results in a production optimum.

According to the invention, the system comprises in each case a sampling element for specimens to be measured, which is provided in an inlet pipe and an outlet pipe of the at least one reactor of the system. At least one gas-phase chromatograph is attached to the system for analysis of the withdrawn specimens to be measured. The withdrawn specimens to be measured are fed by the sampling elements via a heated pipe to the gas-phase chromatograph.

In its basic embodiment, the system can comprise only the reactor, the gas-phase chromatograph and the control unit. The system can comprise at least one reactor, at least one converter, at least one injection tank and at least one vaporizer in a stage of extension according to an embodiment of the invention. Each reactor is provided with an inlet pipe for fresh reaction gas and an outlet pipe for partially used-up reaction gas. Likewise, each converter and each vaporizer is provided with an outlet pipe for a mixture of gases. The outlet pipe of the vaporizer is the inlet pipe for the converter. A sampling element is provided in the outlet pipe of the converter and a sampling element is provided in the outlet pipe for the vaporizer (40).

It makes sense to provide a sampling element for specimens to be measured in the inlet pipe and the outlet pipe of each reactor so that the system can be controlled automatically with regard to the process conditions. Furthermore, in the outlet pipe of each converter also a sampling element is provided. Likewise, a sampling element is provided in the outlet pipe of each vaporizer. The specimens to be measured withdrawn with the various sampling elements are fed to at least one gas-phase chromatograph via a pipe from the sampling element.

The inlet pipe to the at least one reactor basically carries reaction gas to which hydrogen has been admixed to. The outlet pipe of the at least one reactor basically carries abstracted reaction gas. Subject to the executed process (monosilane process or Siemens process) the reaction gas has a different composition and is processed in another range of temperature and with another pressure. From the composition of the abstracted gas in the outlet pipe of the various elements of the system, one can finally suggest the effectivity of the reaction process and discharging process respectively of polycrystalline silicon on the filament rods in the interior space of the reactor.

The outlet pipe of the vaporizer is fed to the converter.

The specimens to be measured should be fed in a gaseous state to the at least one gas-phase chromatograph so that the specimens to be measured which are withdrawn by the sampling elements from the various outlet pipes and/or inlet pipes are withdrawn under conditions which exist at the sampling stations. The pipes are heated from the sampling elements to the at least one gas-phase chromatograph.

A sample recirculation is connected in the system downstream of the at least one gas-phase chromatograph. The specimens to be measured which are analyzed with the gas-phase chromatograph are again introduced into the reaction process of the system. Inside the gas-phase chromatograph a pressure of approximately 2 bar exists with which the specimens to be measured are analyzed. Inside the outlet pipe a pressure of approximately 5 to 7 bar can exist depending on the reaction process in the reactor. Thus it is necessary that the specimens to be measured are at a respective pressure in order to enable an introduction into the outlet pipe system of the system. In order to reach the aforesaid, at least one pipe and at least one intermediate storage is provided, so that the specimens to be measured can be led back into the outlet pipe without influencing the gas-phase chromatograph. Thus it is possible to operate the gas-phase chromatograph in such a way that a removal of the specimens to be measured is not a problem since the specimens to be measured are led back again into the system.

Furthermore, the system comprises a reprocessing system for not used-up reaction gas and other components of the reaction process, which are connected with the outlet pipe of the reactor and with the outlet pipe of the vaporizer. The outlet pipe of the vaporizer also transports the gas from the outlet pipe of the at least one converter to the reprocessing system. The individual components of the reaction gas are again separated from each other in the reprocessing system and led to respective storage tanks or main inputs. The not used-up hydrogen of the reaction gas mixture is led again to the main input of the processing system. Likewise, the components of the reaction gas are separated from each other by the processing system and also led separately from each other to the respective storage tanks.

In order to enable an automatic and safe operation of the system, a control unit is provided which receives signals from the analysis of the withdrawn specimens to be measured by the gas-phase chromatograph. Controlling signals are generated from the signals, which impact on at least one actuator. At least one actuator is related in each case to the elements of the system. Thus, an actuator is related to the at least one reactor and/or to the at least one vaporizer and/or to the at least one converter and/or to the at least one injection tank. The process parameters are automatically adjustable by means of the actuators.

The actuators can be valves for example, which are provided in the inlet pipe to the at least one reactor. With the actuator, the supply of reaction gas in the at least one reactor is controllable. The control and adjustment of the necessary parameters is possible automatically due to the measuring signals of the gas-phase chromatograph.

The method for controlling a system for the production of polycrystalline silicon comprises several steps. The system consists of at least one reactor with at least one inlet pipe and an outlet pipe for a mixture of gases. First of all, specimens to be measured are withdrawn from an inlet pipe and an outlet pipe of the at least one reactor. The withdrawn specimens to be measured are fed to at least one gas-phase chromatograph via a pipe in each case. Controlling signals are obtained on the basis of the measurements with respect to the composition of the fed specimens to be measured. A plurality of parameters of the at least one reactor is adjusted on the basis of the obtained controlling signals by means of a control unit via the actuators in such a way that the efficiency of the system automatically results in a production optimum.

Thereby, the efficiency of the system is that the individual parameters such as pressure, temperature, composition of the reaction gas, composition of the abstract gas from the components of the system, composition and quantity of the mixture of gases, with which the individual elements of the system are fed, are adjusted so that the yield of polycrystalline silicon reaches an optimum.

At least one converter and/or at least one injection tank and/or at least one vaporizer are provided in addition to the at least one reactor. Each reactor is supplied with fresh mixtures of gases via the inlet pipe. Partially used-up mixtures of gases are extracted via the outlet pipe. Likewise, each converter is provided with an outlet pipe for a mixture of gases. Each vaporizer is provided with an outlet pipe for a mixture of gases, wherein the outlet pipe of the vaporizer is the inlet pipe for the converter. The specimens to be measured are likewise withdrawn at the respective withdrawing stations via a sampling element from the outlet pipe of the converter and the outlet pipe of the vaporizer.

These withdrawn specimens to be measured are fed to at least one gas-phase chromatograph via a pipe in each case. Controlling signals are obtained on the basis of the measurements obtained by the gas-phase chromatograph with reference to the composition of the fed specimens to be measured. A plurality of parameters of the at least one reactor and/or of the at least one converter and/or of the at least one vaporizer is adjusted due to the obtained controlling signals in such a way that the efficiency of the system reaches an optimum. The adjustment of these parameters is thereby carried out automatically.

The method according to the invention is also advantageous for putting the system into operation. Thus it is possible with the at least one gas-phase chromatograph to check during putting the system into operation and directly after the finished assembly of the system respectively if water is still available in the system. The system is rinsed with a gas and optionally heated too, so that possible water deposits within the pipe system of the system are eliminated. It is absolutely necessary within the system to avoid any contact of water with reaction gas, since a contact of water and reaction gas causes a highly explosive mixture. Thereby, the usage of the gas-phase chromatograph turns out particularly helpful since it can be proved with the gas-phase chromatograph during putting the system into operation if free water is available within the system. A further advantage of using a gas-phase chromatograph is that the parameters for the deposition of polycrystalline silicon on the filament rods can automatically be adjusted when carrying out the starting up of the system afterwards, so that the optimal operational conditions of the system are reached. On the basis of the withdrawn specimens to be measured it is determined from the data of the gas-phase chromatograph which parameters in the system have to be adjusted with at least one reactor and/or with at least one converter and/or with at least one vaporizer so that the optimal process conditions of a system are reached. As already mentioned, the data obtained with the gas-phase chromatograph are likewise being controlled during the operation of the system. Thus it is ensured that an automatic adjustment of the optimal process conditions of the system is constantly reached.

A recirculation of the specimens to be measured is connected downstream of the at least one gas-phase chromatograph in the system. The recirculation of the specimens to be measured is designed in such a way that in the recirculation of the specimens to be measured the recirculated mixture of gases is at a pressure which corresponds with the pressure in the outlet pipe of the at least one reactor.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a perspective and partially cut view of a reactor for the production of polycrystalline silicon according to the prior art.

FIG. 2 shows a schematic view of the system according to the invention for the production of polycrystalline silicon.

FIG. 3 shows a schematic view of a part of the system for the production of polycrystalline silicon.

FIG. 4 shows a schematic view of another part of the system, in which the converters are basically shown.

FIG. 5 shows a schematic view of the gas-phase chromatograph which is used in the invention at hand.

### DETAILED DESCRIPTION OF THE PREFERRED EMBODIMENTS

Same reference numbers refer to same elements throughout the various figures. Furthermore, only reference numbers necessary for the description of the respective figure or for placing the figure into the context of other figures are shown in the individual figures for the sake of clarity.

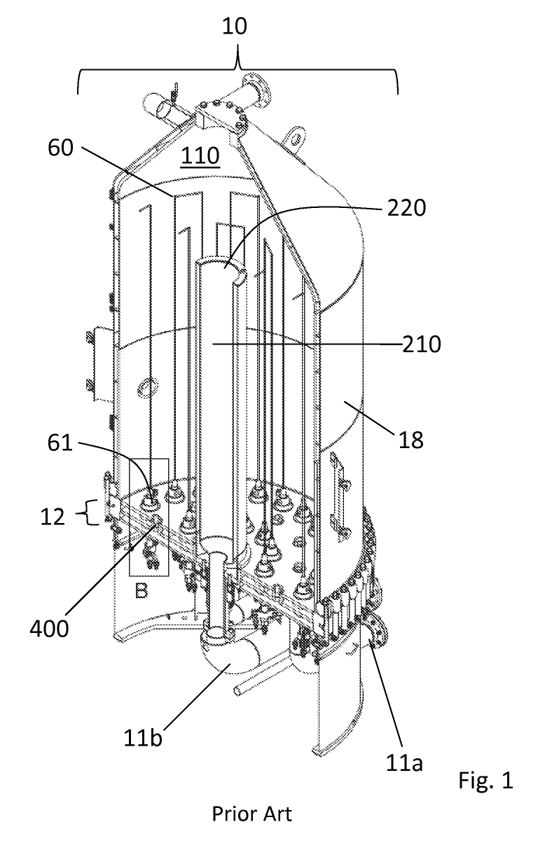

FIG. 1 shows a perspective and partially cut view of a reactor 10 which is used in the system 1 according to the invention. The reactor 10 for the production of polycrystalline silicon is already known from the prior art and designed for the production of polycrystalline silicon according to the monosilane process. The reactor 10 has a reactor base 12 which is provided with a plurality of nozzles 400. Reaction gas, to which hydrogen is admixed to, is injected through the nozzles 400 in the interior space 110 of the reactor 10. Likewise, a plurality of filament rods 60 is placed on the reactor base 12, onto which the polycrystalline silicon is deposited during the process. In the embodiment shown, a gas outlet pipe 11b is provided via an inner pipe 210. The inner pipe 210 has a gas inlet 220 into which the used-up reaction gas enters. The abstracted gas and partially used-up gas respectively is at a certain operational pressure. Thereby, the pressure depends on the used production process. The reactors, the inlet pipes and the outlet pipes for the reaction gas are double-walled in order to reach a certain cooling.

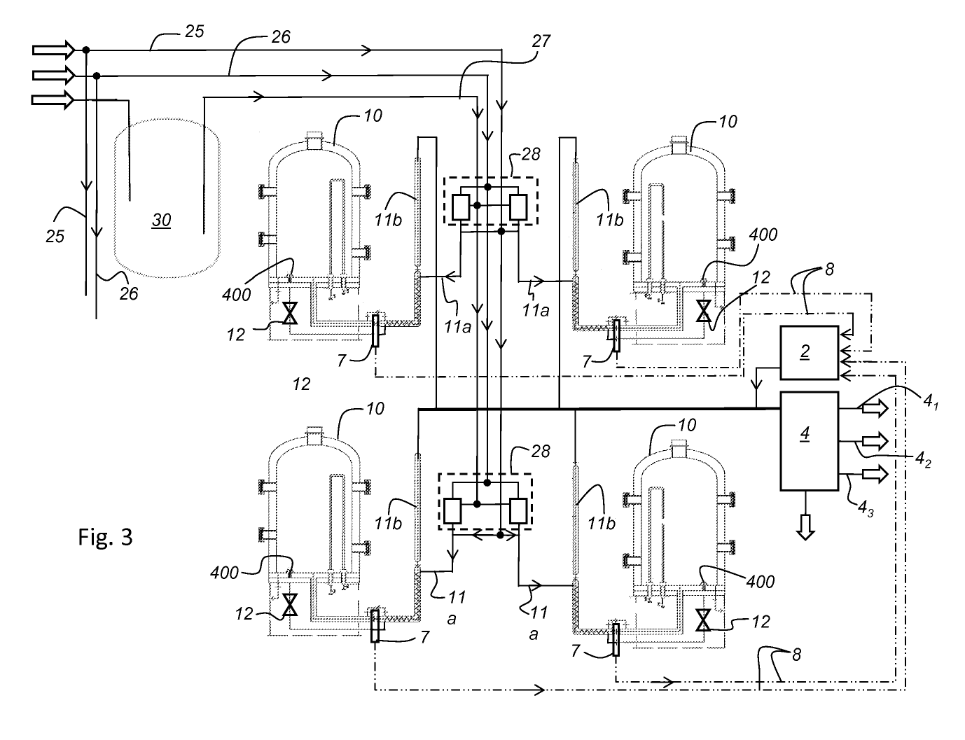

The gas inlet 220 for the inner pipe 210 is clearly spaced from the reactor base 12. This is necessary so that it is ensured that fresh reaction gas which enters the interior space 110 of the reactor does not escape through the gas inlet 220 of the inner pipe 210. The reactor wall 18 and the inlet pipe 210 are double-walled and can be cooled with water. The inner pipe 210 is led through the reactor base 12. The outlet pipe 11b injects the used-up reaction gas to a reprocessing system 4 (see FIG. 3). Likewise, an inlet pipe 11a for fresh reaction gas is provided on the reactor base 12. This inlet pipe 11a ends in the multilayered constructed reactor base 12. The nozzles 400 and the filament rods 60 which are placed in the respective mountings 61 are arranged in the same way about the inner pipe 210 which is positioned in the center of the reactor base 12.

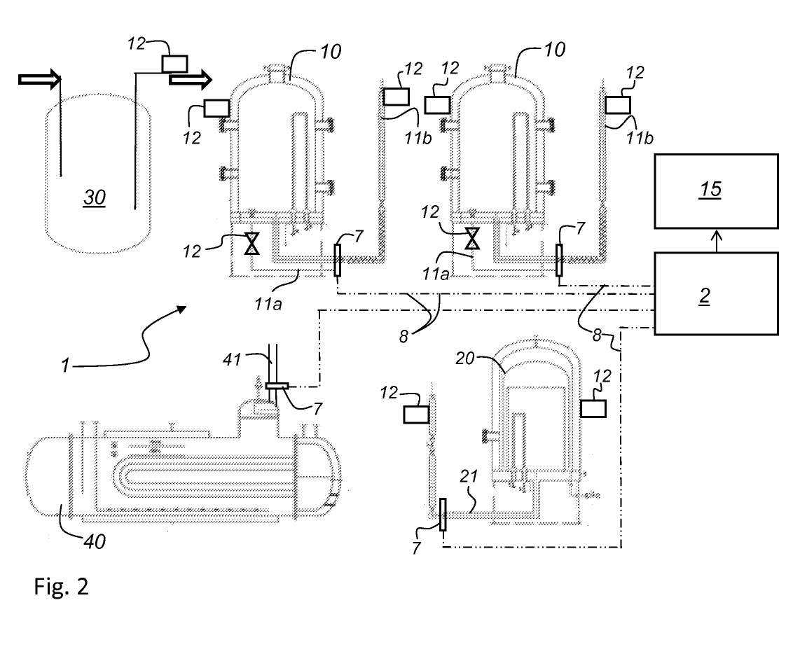

FIG. 2 shows a schematic installation of the system 1 for the production of polycrystalline silicon according to the monosilane process. The system 1 comprises an injection tank 50 via which trichlorosilane is fed into the system 1. Furthermore, the system 1 has several reactors 10 in which the polycrystalline silicon is deposited onto the filament rods 60 (see FIG. 1) intended for this purpose. The reactors are provided with an inlet pipe 11a for fresh reaction gas and an outlet pipe 11b for partially used-up reaction gas. Likewise, at least one vaporizer 40 is provided in the system 1, in which a certain mixture of reaction gas is produced and finally injected to the converters 20. The converters 20 are provided with an outlet pipe 21 which is fed to the vaporizer 40. The abstracted gas from the converter 20 reaches the reprocessing system 4 (see FIG. 3) via the vaporizer 40 and via an outlet pipe 41 leading from the vaporizer 40. Sampling elements 7 are provided both in the inlet pipe 11a and in the outlet pipe 11b of the reactors. Likewise, a sampling element 7 for specimens to be measured is provided in the outlet pipe 21 of the converter 20. A sampling element 7 is provided in the same way in the outlet pipe 41 of the vaporizer 40 for specimens to be measured. Each of the sampling elements 7 is provided with a pipe 8, which leads to a gas-phase chromatograph 2. The individual specimens to be measured are analyzed with reference to their composition in the gas-phase chromatograph 2. The parameters of the individual components (reactor 10, converter 20 and/or vaporizer 40) of the system 1 can be respectively adjusted due to the measuring result so that a possibly high yield of polycrystalline silicon is achieved. Although only two reactors, one converter 20 and one vaporizer 40 are shown in the schematic embodiment of the system 1 in FIG. 2, this shall not be regarded as limiting the invention. It is obvious for a person skilled in the art that several reactors 10 and several converters 20 and also several vaporizers 40 can form a system 1. How many gas-phase chromatographs are finally necessary in order being able to analyze the individual specimens to be measured by the sampling elements 7 depends finally on the size of the whole system.

At least one valve 12 is provided in the inlet pipe for the reactor 10 which is a controlling element of the invention at hand. The inflowing quantity of the reaction gas can be controlled via the valve 12. The adjustment is carried out via the actuators obtained via the gas-phase chromatograph 2. It is obvious for a person skilled in the art that the actuators 12 for adjusting the various parameters of a system 1 for the production of polycrystalline silicon are to be chosen with reference to the parameters adjusted. Likewise, a person skilled in the art already knows the different actuator types which therefore need not to be described in greater detail.

FIG. 3 shows a schematic view of a part of the system 1 for the production of polycrystalline silicon according to the Siemens process. Nitrate is fed via a pipe 25 from a main input to the system 1. Furthermore, hydrogen is fed via a pipe 26 from a main input to the system 1. From a storage tank (not shown), trichlorosilane reaches the injection tank 40. The trichlorosilane is fed from the injection tank 40 via a pipe 27 to at least one gas panel 28 for the reactors 10. A gas panel 28 is provided in each case for two reactors 10. Starting from the gas panel 28 the mixture of gases, which consists of trichlorosilane and hydrogen, is fed via an inlet pipe 11a to the reactors 10 via the nozzles 40. The abstracted gas is injected via an outlet pipe 11b from the reactors 10 finally to a reprocessing system 4. The abstracted gas from the reactors has an operational pressure of 5 to 6 bar. The abstracted gas is being cooled so that the outer walls of the reactors 10 and/or of the converters 20 and/or of the pipes which lead the abstracted gas have a temperature of 100° C. to 150° C. The composition of the abstracted gas from the reactors 10 basically depends on the adjusted process conditions. Thus, the sampling elements 7 for the specimens to be measured are positioned on those positions of the system 1 at which one can suggest the efficiency of the process due to the specimens to be measured. Likewise it is possible to check the efficiency of the process at these positions and to take respective readjustments.

A sampling station 7 for specimens to be measured is in each case provided both in the inlet pipe 11a for fresh reaction gas and in the outlet pipe 11b for abstracted gas from the reactors 10. The specimens to be measured reach the gas-phase chromatograph 2 via pipes 8 which are in each case separated from each other. The pipes 8 which lead from the sampling stations 7 to the gas-phase chromatograph 2 are shown in the embodiments of FIGS. 2, 3, and 4, in a dashed-dotted way. The reprocessing system 4 for the abstracted gas provides hydrogen in a first pipe 4₁, trichlorosilane in a second pipe 4₂, and tetrachlorosilane in a third pipe 4₃. Trichlorosilane and tetrachlorosilane are directly led to a storage tank (not shown).

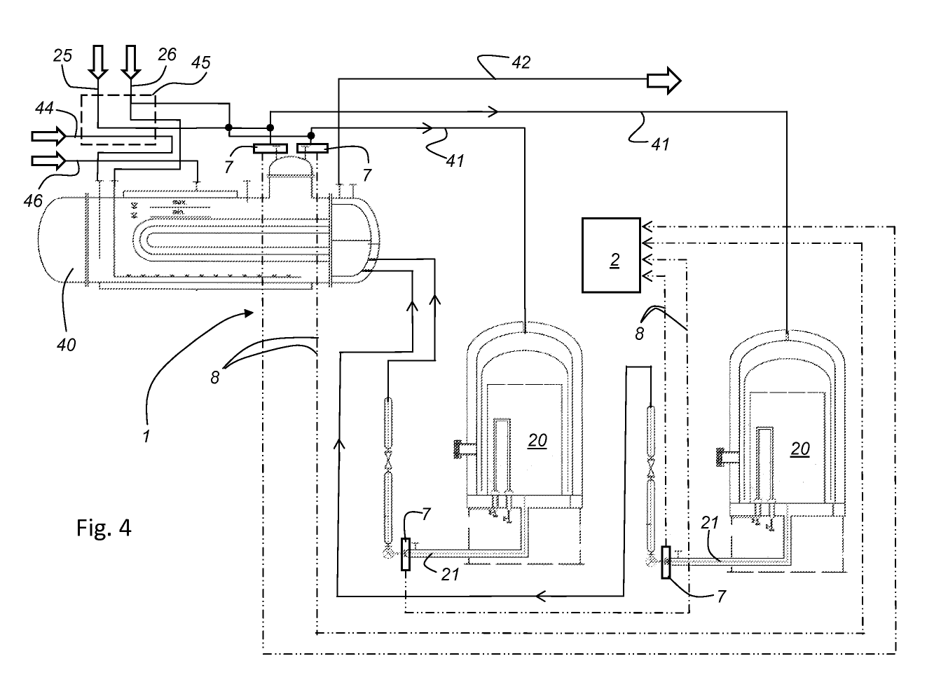

FIG. 4 shows a schematic partial view of the system 1 for the production of polycrystalline silicon (likewise according to the Siemens process), in which the vaporizer 40 and several converters 20 are shown. Tetrachlorosilane is led to the vaporizer 40 via a pipe 44 from a storage tank (not shown). Likewise, steam is led to the vaporizer 40 via a pipe 46. Nitrate reaches a gas panel 45 for the converter via a pipe 25. Hydrogen reaches the gas panel 45 via a pipe 26. The vaporizer 40 is provided with at least one outlet 41 which leads to a converter 20 in each case. The outlet pipe 41 leads a mixture of gases of tetrachlorosilane and hydrogen to the converters 20. The converter 20 has in each case an outlet pipe 21 for reaction gas. A sampling station 7 for specimens to be measured is provided both in the outlet pipes 21 of the converters 20 and in the outlet pipes 41 of the vaporizer 40 for mixtures of gases of tetrachlorosilane and hydrogen. As already mentioned in the description of FIG. 3, in each case a pipe 8 leads from each sampling station 7 to the gas-phase chromatograph 2. Furthermore, the outlet pipe 42 of the reaction gas from the converters 20 leads via the vaporizer 40. The outlet pipe 41 from the vaporizer 40 reaches also the reprocessing system 4. The pipes 8 of the sampling elements 7 for the specimens to be measured shown in the FIGS. 3 and 4 are heated in such a way that the specimens to be measured are fed to the gas-phase chromatograph in a gaseous state.

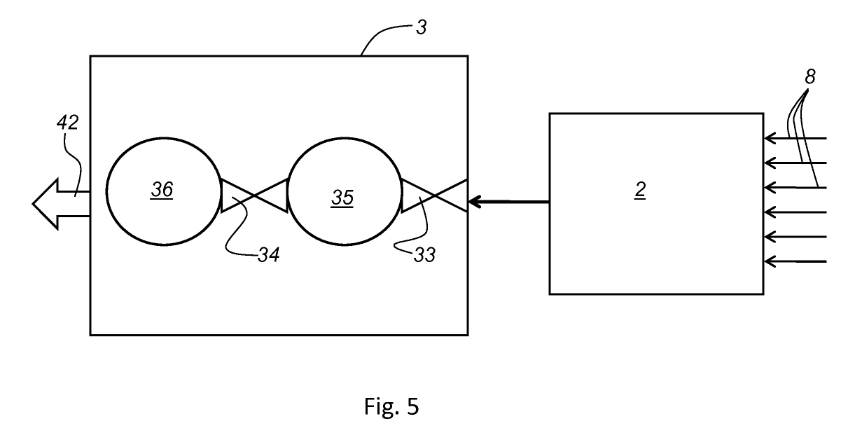

FIG. 5 shows a schematic view of how the specimens to be measured, which were analyzed by the gas-phase chromatograph 2, are finally fed back into the outlet pipe 42. As already mentioned, a pressure of approximately 5 to 7 bar exists in the outlet pipes 42 for the specimens to be measured. This pressure exists in the outlet pipe 42 if the system 1 is operated according to the Siemens process. A lesser pressure exists in the monosilane process than in the Siemens process. The gas-phase chromatograph 2 processes the specimens to be measured with a pressure of approximately 2 bar. A sample recirculation 3 is connected downstream of the gas-phase chromatograph 2 so that the specimens to be measured are at the required pressure, which prevails in the outlet pipes 42. The sample recirculation 3 has a pump 33 which injects the specimens to be measured in a first intermediate storage 35, in which a pressure of approximately 2 to 3 bar prevails. The specimens to be measured are injected with a second pump 34 from the first intermediate storage 35 into the second intermediate storage 36. A pressure of 5 to 7 bar prevails in the second intermediate storage 36, which basically corresponds to the pressure in the outlet pipe. The specimens to be measured are finally transferred from the second intermediate storage 36 into the outlet pipe 42 again.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for the production of polycrystalline silicon comprising:
at least one reactor;
in each case a sampling element for specimens to be measured is provided in an inlet pipe and an outlet pipe of the at least one reactor;
at least one gas-phase chromatograph for analyzing the withdrawn specimens; and
a pipe connects each sampling element and the gas-phase chromatograph.

2. The system of claim 1, wherein at least one converter and/or at least one injection tank and/or at least one vaporizer are provided in addition to the at least one reactor, that each reactor is provided with the inlet pipe for fresh mixtures of gases and the outlet pipe for partially used-up mixtures of gases, that each converter is provided with an outlet pipe for a mixture of gases and each vaporizer is provided with an outlet pipe for a mixture of gases, wherein the outlet pipe of the vaporizer is the inlet pipe for the converter and that likewise a sampling element is provided in the outlet pipe of the converter and a sampling element is provided in the outlet pipe for the vaporizer.

3. The system of claim 2, wherein in each case a pipe from each of the sampling elements is connected with the gas-phase chromatograph.

4. The system of claim 3, wherein the pipes leading from the sampling elements to the at least one gas-phase chromatograph are heated, so that the withdrawn samples are in a gaseous state.

5. The system of claim 1, wherein a sample recirculation is connected in the system downstream of the at least one gas-phase chromatograph, wherein the sample recirculation is designed in such a way that the recirculated mixture of gases in the sample recirculation is at a pressure which is in accordance with the pressure in the outlet pipe of the at least one reactor.

6. The system of claim 5, wherein a reprocessing system for gas is provided, which is connected with the outlet pipe of the reactor and with an outlet pipe of the vaporizer, wherein the outlet pipe also transports the gas from the outlet pipe of the at least one converter.

7. The system of claim 1, wherein a control unit is provided, which receives signals from the analysis of the withdrawn specimens to be measured and generates control signals thereof, which act on at least one actuator, which is related to the at least one reactor (10) and/or at least one vaporizer and/or at least one converter and/or at least one injection tank and wherein the process parameters are automatically adjusted by means of the actuators.

8. The system of claim 7, wherein the actuator in the inlet pipe to the at least one reactor is a valve, with which the supply of reaction gas into the at least one reactor is automatically controllable due to the measuring signals of the gas-phase chromatograph.

9. A method for controlling a system for the production of polycrystalline silicon, wherein the system has at least one reactor with at least one inlet pipe and an outlet pipe for a mixture of gases, comprising the following steps:
withdrawing specimens to be measured from the inlet pipe and the outlet pipe of each reactor;
feeding the withdrawn specimens to be measured to at least one gas-phase chromatograph via a pipe;
obtaining controlling signals on the basis of the measurements with respect to the composition of the fed specimens to be measured obtained by the gas-phase chromatograph; and
adjusting a plurality of parameters of the at least one reactor on the basis of the obtained controlling signals by means of a control unit via actuators n such a way that the efficiency of the system automatically results in a production optimum.

10. The method of claim 9, wherein at least a converter and/or at least an injection tank and/or at least a vaporizer are provided in addition to the at least one reactor, that each reactor comprises the inlet pipe for fresh mixtures of gases and the outlet pipe for partially exhausted mixtures of gases, that each converter comprises an outlet pipe for a mixture of gases and each vaporizer an outlet pipe for a mixture of gases, wherein the outlet pipe of the vaporizer is the inlet pipe for the converter and that likewise a sampling element is provided in the outlet pipe of the converter and a sampling element is provided in the outlet pipe for the vaporizer.

11. The method of claim 10, wherein the specimens to be measured are withdrawn by sampling elements and fed via the pipes, which are heated, to the at least one gas-phase chromatograph.

12. The method of claim 9, wherein a sample recirculation is connected in the system downstream of the at least one gas-phase chromatograph, wherein the sample recirculation is designed in such a way that the recirculated mixture of gases in the sample recirculation is at a pressure which is in accordance with the pressure in the outlet pipe of the at least one reactor.

13. The method of claim 9, wherein the at least one gas-phase chromatograph tests any existence of water in the system when putting the system into operation and that afterwards the parameters of the at least one reactor and/or of the at least one converter and/or of the at least one vaporizer are adjusted and altered in such a way when commissioning the system that an automatic start-up of the system on the process conditions is carried out due to the controlling signals obtained by means of the at least one gas-phase chromatograph.

14. The method of claim 9, wherein a control unit is provided, which receives signals from the analysis of the withdrawn specimens to be measured and generates control signals thereof, which impact on at least one actuator, which is related to the at least one reactor and/or the at least one vaporizer and/or the at least one converter and/or the at least one injection tank and wherein the process parameters are automatically adjustable by means of the actuators.

15. The method of claim 14, wherein the actuator in the inlet pipe to the at least one reactor is a valve, with which the supply of reaction gas into the at least one reactor is automatically controllable due to the measuring signals of the gas-phase chromatograph.
